(19) United States
(12) Patent Application Publication
(10) Pub. No.: US 2026/0153423 A1
(43) Pub. Date: Jun. 4, 2026

(54) METHOD FOR PREDICTING SURFACE TENSION OF (H2+N2)/H2O SYSTEM BASED ON LINEAR GRADIENT THEORY (LGT) AND PERKINS-RAMMLER (PR) STATE EQUATION

(71) Applicant: Jiangsu University, Jiangsu (CN)

(72) Inventors: Bifeng YIN, Jiangsu (CN); Fei DONG, Jiangsu (CN); Hekun JIA, Jiangsu (CN); Jie NI, Jiangsu (CN)

(73) Assignee: Jiangsu University, Jiangsu (CN)

(21) Appl. No.: 18/851,700

(22) PCT Filed: Jan. 10, 2024
(86) PCT No.: PCT/CN2024/071504

§ 371 Date: Sep. 27, 2024

(30) Foreign Application Priority Data
Sep. 8, 2023 (CN) 202311158102.1

(51) Int. Cl. G01N 13/02; G06F 17/11

(52) U.S. Cl. CPC G01N 13/02; G06F 17/11

(57) ABSTRACT

The provided method includes: determining an energy parameter and a co-volume parameter of a pure gas by a PR state equation, and determining a material parameter and a co-volume parameter of a mixed gas by a Waals one-fluid mixing rule and a combination rule; determining a Helmholtz free energy density and an equilibrium density of the pure gas by a Wertheim molecular association theory, and determining Helmholtz free energy and an equilibrium density of a (H₂+N₂) mixed gas with different components by a density mixing rule; determining an influence parameter of the pure gas by a gradient theory (GT), and determining an influence parameter of the mixed gas by the influence parameter of the pure gas and an interaction coefficient; simplifying a GT model; and obtaining the surface tension of the (H₂+N₂)/H₂O system at different temperatures by combining the LGT model and the PR state equation.

### TECHNICAL FIELD

The present disclosure relates to the field of gas-liquid mixture model prediction, and in particular, to a method for predicting surface tension of a (H₂+N₂)/H₂O system based on a linear gradient theory (LGT) and a Perkins-Rammler (PR) state equation.

### RELATED ART

A gas-liquid two-phase flow behavior on a microscopic interface is currently a research hotspot. However, in current studies, a role of surface tension in a microstructure is often ignored. The surface tension is a fundamental thermophysical property but can be easily ignored in a practical application. In a microenvironment, an effect of the surface tension on a gas-liquid mixture cannot be ignored. At present, experimental measurement of surface tension involving water and various gases has been widely studied, but there is still a lack of corresponding surface tension data for a ternary system with different components. Therefore, it is necessary to develop some prediction models to calculate the surface tension of the ternary system with different components.

Although there have been reports on a prediction model of surface tension of a gas-liquid system, the prediction model is usually used for a pure gas in a binary system. For this situation, a gradient theory (GT) model and a cubic-plus-association equation of state (CPA-EoS) are usually used for simultaneous solution. For a mixed gas in the ternary system, an experimental research method is mainly used, and there are few theoretical prediction models.

### SUMMARY OF INVENTION

In order to overcome the shortcomings in the prior art, the present disclosure provides a method for predicting surface tension of a (H₂+N₂)/H₂O system based on an LGT and a PR state equation. A coefficient for interaction between pure gases N₂ and H₂ is fitted experimentally, and values of an interaction coefficient lₘᵢₓₜᵤᵣₑ of a mixed gas with different components at different temperatures are calculated by using a non-random two liquid (NRTL) equation, thereby overcoming a disadvantage that an interaction coefficient of a mixed gas in a ternary system can only be fitted experimentally. A material parameter of a pure gas is solved by using a PR state equation, which can accurately calculate a material parameter of a mixture in the ternary system. Helmholtz free energy and an equilibrium density of the pure gas are solved by using a Wertheim molecular association theory. A GT is simplified by using a density gradient linearization theory, to eliminate the need for complexly solving an inherent density distribution equation in the GT. Finally, a simplified GT model LGT is combined with a CPA-EOS method to predict surface tension of the (H₂+N₂)/H₂O system at different temperatures.

The present disclosure achieves the above technical objective through following technical solutions.

A method for predicting surface tension of a (H₂+N₂)/H₂O system based on an LGT and a Perkins-Rammler (PR) state equation includes following steps:
determining an energy parameter and a co-volume parameter of a pure gas based on the PR state equation, and determining a material parameter and a co-volume parameter of a mixed gas according to a Waals one-fluid mixing rule and a combination rule;
determining a Helmholtz free energy density and an equilibrium density of the pure gas by using a Wertheim molecular association theory, and determining Helmholtz free energy fₘᵢₓₜᵤᵣₑ(ρ) and an equilibrium density ρ_{b,mixture} of a (H₂+N₂) mixed gas with different components according to a density mixing rule;
determining an influence parameter κ of the pure gas by using a GT, and determining an influence parameter of the mixed gas based on the influence parameter (κ_{H}_{₂}, κ_{N}_{₂}) of the pure gas and an interaction coefficient lₘᵢₓₜᵤᵣₑ;
simplifying a GT model to obtain a simplified GT model, namely an LGT model; and
obtaining the surface tension of the (H₂+N₂)/H₂O system at different temperatures by combining the LGT model and the PR state equation.

Further, the determining the energy parameter and the co-volume parameter of the pure gas based on the PR state equation, and determining the material parameter and the co-volume parameter of the mixed gas according to the Waals one-fluid mixing rule and the combination rule includes following steps:
determining the energy parameter a and the co-volume parameter b of the pure gas based on a thermophysical parameter of the pure gas specifically as follows:

$$a = 0. 46 \frac{{( R {T}_{c} )}^{2}}{{p}_{c}} α ( T )$$

$$b = 0. 08 \frac{R {T}_{c}}{{p}_{c}}$$

$$α ( T ) = {[ 1 + m ( 1 - \sqrt{\frac{T}{{T}_{c}}} ) ]}^{2}$$

where T_{c} represents a critical temperature of the pure gas, p_{c} represents a critical pressure of the pure gas, R represents a gas constant, T represents an ambient temperature, and m represents a coefficient related to an eccentric factor of the pure gas;
according to the above formulas, obtaining a thermophysical parameter of pure nitrogen to determine an energy parameter a_{N}_{₂} and a co-volume parameter b_{N}_{₂} of the pure nitrogen, and obtaining a thermophysical parameter of pure hydrogen to determine an energy parameter a_{H}_{₂} and a co-volume parameter b_{H}_{₂} of the pure hydrogen; and
determining the material parameter aₘᵢₓₜᵤᵣₑ and the co-volume parameter bₘᵢₓₜᵤᵣₑ of the mixed gas with different components according to the Waals one-fluid mixing rule as follows:

$$\{ \begin{matrix}{a}_{m i x t u r e} = \sqrt{{x}_{{H}_{2}} {x}_{{N}_{2}} {a}_{{H}_{2}} {a}_{{N}_{2}}} ( 1 - {k}_{m i x t u r e} ) \\ {b}_{m i x t u r e} = \frac{1}{2} ( {x}_{{H}_{2}} {b}_{{H}_{2}} + {x}_{{N}_{2}} {b}_{{N}_{2}} ) ( 1 - {l}_{m i x t u r e} )\end{matrix}$$

where lₘᵢₓₜᵤᵣₑ represents the interaction coefficient of the mixed gas, where the interaction coefficient lₘᵢₓₜᵤᵣₑ of the mixed gas with different components is calculated based on an NRTL equation; x_{H}_{₂} represents a volume fraction of hydrogen in the mixed gas; x_{N}_{₂} represents a volume fraction of nitrogen in the mixed gas; kₘᵢₓₜᵤᵣₑ represents a binary interaction parameter, where for a (H₂+N₂) mixed gas, the binary interaction parameter kₘᵢₓₜᵤᵣₑ is defined as follows:

$${k}_{m i x t u r e} = 0.99 - \frac{379.97}{T} .$$

Further, the interaction coefficient lₘᵢₓₜᵤᵣₑ of the mixed gas with different components is calculated based on the NRTL equation, specifically including:
fitting experimental data to obtain a binary interaction coefficient l_{H}_{₂} of the pure hydrogen and a binary interaction coefficient l_{N}_{₂} of the pure nitrogen; and
calculating values of the interaction coefficient lₘᵢₓₜᵤᵣₑ of the mixed gas with different components at different temperatures based on the NRTL equation, where a calculation formula is as follows:

$$ln ( {l}_{m i x t u r e} ) = {{x}_{{H}_{2}}}^{2} * ( \frac{{G}_{1}}{R T} ) * {l}_{{H}_{2}} + {{x}_{{N}_{2}}}^{2} * ( \frac{{G}_{2}}{R T} ) * {l}_{{N}_{2}} + 2 {x}_{{H}_{2}} {x}_{{N}_{2}} * ( \frac{{G}_{3}}{R T} )$$

where, G₁, G₂, and G₃ represent calculation parameters of an empirical correlation equation.

Further, the determining the Helmholtz free energy density and the equilibrium density of the pure gas by using the Wertheim molecular association theory includes following steps:
determining a pressure factor P as follows:

$$P = - \frac{1}{2} ( 1 + ρ \frac{\partial ln g ( ρ )}{\partial ρ} ) \sum ( 1 - {X}_{A} )$$

where ρ represents a molar density; and g(ρ) represents a radial distribution function of a hard sphere (HDS), where the g(ρ) is simplified as follows:

$$g ( ρ ) = \frac{1}{1 - 1.9 η} , η = \frac{1}{4} b ρ$$

X_{A} represents an important parameter for an associated term in a mixture, and is specifically as follows:

$${X}_{A} = \frac{1}{1 + ρ Δ}$$

where a self-association molecule Δ represents association strength (self-association) between gas molecules, which is given according to a following formula:

$$Δ = g ( ρ ) [ exp ( \frac{ε}{R T} ) - 1 ] b β$$

where ε represents an association energy of the pure gas; β represents an association volume of the pure gas; and b represents the co-volume parameter of the pure gas, where b is b_{H}_{₂} when calculation is performed on pure hydrogen and is b_{N}_{₂} when the calculation is performed on pure nitrogen;
obtaining the equilibrium density ρ_{b} of the pure gas according to a following formula:

$${ρ}_{b} = \frac{P}{R T} ;$$

obtaining the Helmholtz free energy f(ρ) of the pure gas according to a following formula:

$$f ( ρ ) = {μ}_{s} - P * \frac{RT}{{p}_{0}} ;$$

where μₛ represents a chemical potential of the pure gas, and a value of the chemical potential is obtained by looking up a table; and p₀ represents atmospheric pressure of a current environment; and
obtaining an equilibrium density ρ_{H}_{₂}_{b} of the pure hydrogen, an equilibrium density ρ_{N}_{₂}_{b} of the pure nitrogen, Helmholtz free energy f_{H}_{₂}_{(ρ)} of the pure hydrogen, and Helmholtz free energy f_{N}_{₂}_{(ρ)} of the pure nitrogen.

Further, the determining the Helmholtz free energy fₘᵢₓₜᵤᵣₑ(ρ) and the equilibrium density ρ_{b,mixture} of the (H₂+N₂) mixed gas with different components according to the density mixing rule is specifically as follows:

$${f}_{mixture} ( ρ ) = {x}_{{H}_{2}} {f}_{{H}_{2} ( ρ )} + {x}_{{N}_{2}} {f}_{{N}_{2} ( ρ )}$$

$${ρ}_{b , mixture} = {x}_{{H}_{2}} {ρ}_{{H}_{2} b} + {x}_{{N}_{2}} {ρ}_{{N}_{2} b} .$$

Further, the determining the influence parameter κ of the pure gas by using the GT specifically includes following steps:
performing temperature function fitting on an influence parameter of a pure gas that is known, to obtain a general expression, where the general expression is as follows:

$$\frac{κ}{{ab}^{2 / 3}} = {A ( 1 - \frac{T}{{T}_{C}} )}^{B}$$

where coefficient A=f(ω), coefficient B=f(ω²), ω represents an eccentric factor of the pure gas, and the f(ω) and the f(ω²) are determined experimentally based on an influence parameter of the pure gas that is known; and
calculating an influence parameter κ_{H}_{₂} of pure hydrogen and an influence parameter κ_{N}_{₂} of pure nitrogen.

Further, the determining the influence parameter of the mixed gas based on the influence parameter (κ_{H}_{₂}, κ_{N}_{₂}) of the pure gas and the interaction coefficient lₘᵢₓₜᵤᵣₑ is specifically as follows:

$$the influence parameter of the mixed gas {κ}_{m i x t u r e} = \sqrt{{κ}_{{H}_{2}} {κ}_{{N}_{2}}} ( 1 - {l}_{m i x t u r e} ) .$$

Further, the simplifying the GT model is specifically as follows: obtaining the simplified GT model, namely the LGT model, by using a density gradient linearization theory and by assuming that a density of a component i in a mixture is linearly distributed between equilibrium phases, without solving an inherent density distribution equation in the GT.

Further, the obtaining the surface tension of the (H₂+N₂)/H₂O system at the different temperatures by combining the LGT model and the PR state equation is specifically as follows:
the simplified GT model, namely the LGT model is as follows:

$$γ = {\int }_{{ρ}_{b}^{I}}^{{ρ}_{b}^{II}} \sqrt{2 κ ( Ω ( ρ ) - {P}_{s} )} d {ρ}_{b , mixture}$$

where γ represents a surface tension coefficient. Pₛ represents a pressure in a phase equilibrium state, ρ represents a molar density of a bulk phase, superscripts I and II respectively represent components H₂ and N₂ of the mixed gas,

$${ρ}_{b}^{I}$$

represents a hydrogen density under a current component and temperature condition, and

$${ρ}_{b}^{II}$$

represents a nitrogen density under a current component and temperature condition;
based on a density gradient linearization theory, a corrected influence parameter of the mixed gas is calculated as follows:

$$κ = \sum \sum {κ}_{mixture} \frac{{Δρ}_{{H}_{2}}}{{Δρ}_{b}} \frac{{Δρ}_{{N}_{2}}}{{Δρ}_{b}}$$

where

$${Δρ}_{b} = max ( {ρ}_{b}^{′} - {ρ}_{b}^{II} ) ,$$

Δρ_{H}_{₂} represents a difference between the hydrogen density and the equilibrium density of the mixed gas, and Δρ_{N}_{₂} represents a difference between the nitrogen density and the equilibrium density of the mixed gas; and
Ω(ρ) represents total thermodynamic potential energy, and is defined as follows:

$$Ω ( ρ ) = {f}_{mixture} ( p ) - {ρ}_{b , mixture} * {μ}_{s , mixture}$$

where fₘᵢₓₜᵤᵣₑ(ρ) represents the Helmholtz free energy of the mixed gas when a reference density is ρ, and ρ_{b,mixture} represents the equilibrium density of the mixed gas.

A system for predicting surface tension of a (H₂+N₂)/H₂O system based on an LGT and a PR state equation includes a storage medium, where the storage medium is configured to store a program for compiling the method for predicting the surface tension of the (H₂+N₂)/H₂O system based on the LGT and the PR state equation.

The present disclosure has following advantages:

1. The method for predicting surface tension of a (H₂+N₂)/H₂O system based on an LGT and a PR state equation in the present disclosure can accurately predict surface tension of a (H₂+N₂)/H₂O system at different temperatures.

2. The method for predicting surface tension of a (H₂+N₂)/H₂O system based on an LGT and a PR state equation in the present disclosure experimentally fits a coefficient for interaction between pure gases N₂ and H₂, and calculates values of an interaction coefficient lₘᵢₓₜᵤᵣₑ of a mixed gases with different components at different temperatures by using an NRTL equation, overcoming an disadvantage that an interaction coefficient of a mixed gas in a ternary system can only be fitted experimentally.

3. The method for predicting surface tension of a (H₂+N₂)/H₂O system based on an LGT and a PR state equation in the present disclosure solves a material parameter of a pure gas by using a PR state equation, which can accurately calculate material parameters of mixtures in a binary system and the ternary system, and solves Helmholtz free energy and an equilibrium density of the pure gas by using a Wertheim molecular association theory.

4. The method for predicting surface tension of a (H₂+N₂)/H₂O system based on an LGT and a PR state equation in the present disclosure simplifies a GT by using a density gradient linearization theory, such that there is no need for complexly solving an inherent density distribution equation in the GT, and predicts the surface tension of the (H₂+N₂)/H₂O system at the different temperatures by combining an LGT and a PR state equation method.

### BRIEF DESCRIPTION OF DRAWINGS

To describe the technical solutions in the embodiments of the present disclosure or in the prior art clearly, the accompanying drawings required for describing the embodiments or the prior art will be briefly described below. Apparently, the accompanying drawings in the following description show some embodiments of the present disclosure, and a person of ordinary skill in the art may still derive other accompanying drawings from these accompanying drawings without creative efforts.

FIG. 1 is a flowchart of a model for predicting surface tension of a (H₂+N₂)/H₂O system based on an LGT and a PR state equation according to the present disclosure;

FIG. 2 shows a calculation process of a PR state equation method according to the present disclosure;

FIG. 3 shows a calculation process of a Wertheim molecular association theory according to the present disclosure;

FIG. 4 shows a result of calculating an equilibrium density according to the present disclosure;

FIG. 5 shows a calculation process of an influence parameter in a GT according to the present disclosure;

FIG. 6 is a schematic diagram of a calculation result of an interaction coefficient of a ternary system according to the present disclosure; and

FIG. 7 shows a result of predicting surface tension of a (H₂+N₂)/H₂O system according to the present disclosure.

### DESCRIPTION OF EMBODIMENTS

The embodiments of the present disclosure are described below in detail. Examples of the embodiments are shown in the accompanying drawings. The same or similar numerals represent the same or similar elements or elements having the same or similar functions throughout the specification. The embodiments described below with reference to the accompanying drawings are exemplary, and are intended to explain the present disclosure but should not be construed as a limitation to the present disclosure.

It should be understood that, in the description of the present disclosure, orientations or position relationships indicated by terms such as “central”, “longitudinal”, “transverse”, “length”, “width”, “thickness”, “upper”, “lower”, “axial”, “radial”, “vertical”, “horizontal”, “inner”, and “outer” are based on the orientations or position relationships shown in the accompanying drawings. These terms are merely intended to facilitate a simple description of the present disclosure, rather than to indicate or imply that the mentioned apparatus or elements must have a specific orientation or be constructed and operated in a specific orientation. Therefore, these terms may not be construed as a limitation to the present disclosure. In addition, the terms “first” and “second” are merely intended for a purpose of description, and shall not be understood as indicating or implying relative importance or implying a quantity of indicated technical features. Thus, features defined with “first” and “second” may explicitly or implicitly include one or more of the features. In the description of the present disclosure, “a plurality of” means two or more, unless otherwise specifically defined.

In the present disclosure, unless otherwise clearly specified and limited, the terms “installed”, “connected with”, “connected to”, and “fixed” should be understood in a board sense. For example, the connection may be a fixed connection, a detachable connection, or an integrated connection, may be a mechanical connection or an electrical connection, may be a direct connection or an indirect connection via an intermediate medium, or may be intercommunication between two components. Those of ordinary skill in the art may understand specific meanings of the above terms in the present disclosure based on a specific situation.

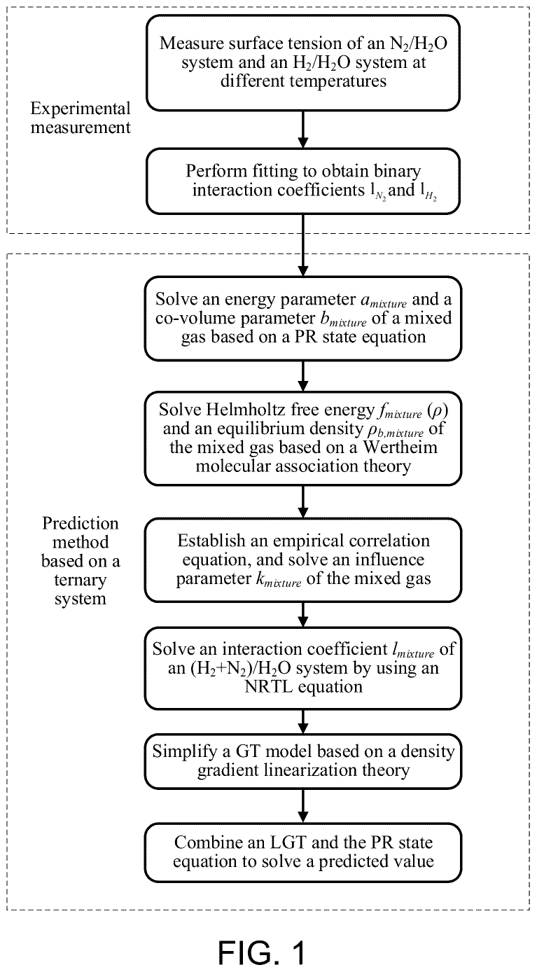

In order to accurately predict surface tension of a (H₂+N₂)/H₂O system and calculate an interaction coefficient of the ternary system, the present disclosure provides a method for predicting surface tension of a (H₂+N₂)/H₂O system based on an LGT and a PR state equation. As shown in FIG. 1, the method includes following steps:

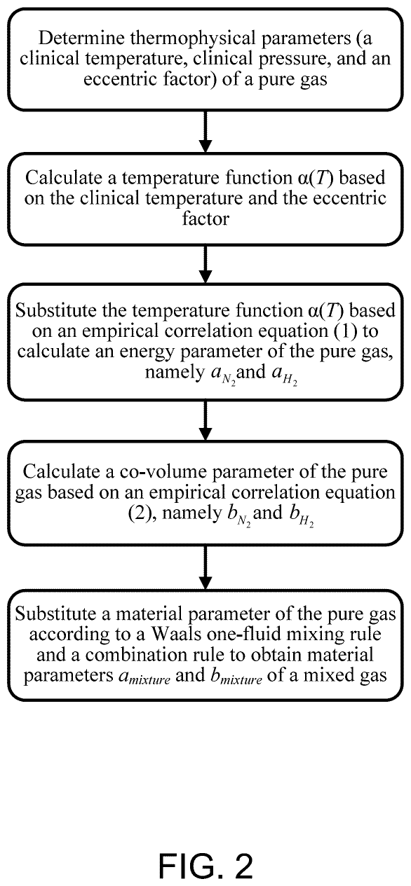

S01: An energy parameter and a co-volume parameter of a pure gas are determined based on the PR state equation, and a material parameter and a co-volume parameter of a mixed gas are determined according to a Waals one-fluid mixing rule and a combination rule. As shown in FIG. 2, following steps are included:

S1.1: An energy parameter a_{H}_{₂} and a co-volume parameter b_{H}_{₂} of pure hydrogen are determined based on a thermophysical parameter of the pure hydrogen, specifically as follows:

$${a}_{{H}_{2}} = 0.46 \frac{{( {RT}_{c - {H}_{2}} )}^{2}}{{p}_{c - {H}_{2}}} {α ( T )}_{{H}_{2}}$$

$${b}_{{H}_{2}} = 0.08 \frac{{RT}_{c - {H}_{2}}}{{p}_{c - {H}_{2}}}$$

$${α ( T )}_{{H}_{2}} = {[ 1 + {m}_{{H}_{2}} ( 1 - \sqrt{\frac{T}{{T}_{c - {H}_{2}}}} ) ]}^{2}$$

where, T_{c-H}_{₂} represents a critical temperature of the pure hydrogen, p_{c-H}_{₂} represents critical pressure of the pure hydrogen, R represents a gas constant, T represents an ambient temperature, and m_{H}_{₂} represents a coefficient related to an eccentric factor of the pure hydrogen, and m_{H}_{₂}=0.024.

S1.2: An energy parameter a_{N}_{₂} and a co-volume parameter b_{N}_{₂} of pure nitrogen are determined based on a thermophysical parameter of the pure nitrogen, which is specifically as follows:

$${a}_{{N}_{2}} = 0.46 \frac{{( {RT}_{c - {N}_{2}} )}^{2}}{{p}_{c - {N}_{2}}} α {( T )}_{{N}_{2}}$$

$${b}_{{N}_{2}} = 0.08 \frac{{RT}_{c - {N}_{2}}}{{p}_{c - {N}_{2}}}$$

$${α ( T )}_{{N}_{2}} = {[ 1 + {m}_{{N}_{2}} ( 1 - \sqrt{\frac{T}{{T}_{c - {N}_{2}}}} ) ]}^{2}$$

where, T_{c-N}_{₂} represents a critical temperature of the pure nitrogen, p_{c-H}_{₂} represents a critical pressure of the pure nitrogen, R represents the gas constant, which is set to 8.314 J/(mol·K), T represents the ambient temperature, and m_{N}_{₂} represents a coefficient related to an eccentric factor of the pure nitrogen, and m_{H}_{₂}=0.43.

S1.3: A material parameter aₘᵢₓₜᵤᵣₑ and a co-volume parameter bₘᵢₓₜᵤᵣₑ e of a gas mixture with different components are determined according to the Waals one-fluid mixing rule, where the mixing rule is as follows:

$$\{ \begin{matrix}{a}_{mixture} = \sqrt{{x}_{{H}_{2}} {x}_{{N}_{2}} {a}_{{H}_{2}} {a}_{{N}_{2}}} ( 1 - {k}_{mixture} ) \\ {b}_{mixture} = \frac{1}{2} \sqrt{{x}_{{H}_{2}} {b}_{{H}_{2}} + {x}_{{N}_{2}} {b}_{{N}_{2}}} ( 1 - {l}_{mixture} )\end{matrix}$$

where, lₘᵢₓₜᵤᵣₑ represents an interaction coefficient of the mixed gas; x_{H}_{₂} represents a volume fraction of hydrogen in the mixed gas; x_{N}_{₂} represents a volume fraction of nitrogen in the mixed gas; kₘᵢₓₜᵤᵣₑ represents a binary interaction parameter, which is temperature dependent, where for a (H₂+N₂) mixed gas, the binary interaction parameter kₘᵢₓₜᵤᵣₑ is defined as follows:

$${k}_{mixture} = 0.99 - \frac{379.97}{T} .$$

The interaction coefficient lₘᵢₓₜᵤᵣₑ of the mixed gas with different components is calculated based on an NRTL equation, which is specifically as follows:

Experimental data is fitted to obtain a binary interaction coefficient l_{H}_{₂} of the pure hydrogen and a binary interaction coefficient l_{N}_{₂} of the pure nitrogen.

Values of the interaction coefficient lₘᵢₓₜᵤᵣₑ of the mixed gas with different components at different temperatures are calculated based on the NRTL equation. A calculation formula is as follows:

$$ln ( {l}_{mixture} ) = {{x}_{{H}_{2}}}^{2} * ( \frac{{G}_{1}}{RT} ) * {l}_{{H}_{2}} + {{x}_{{N}_{2}}}^{2} * ( \frac{{G}_{2}}{RT} ) * {l}_{{N}_{2}} + 2 {x}_{{H}_{2}} {x}_{{N}_{2}} * ( \frac{{G}_{3}}{RT} )$$

where, G₁, G₂, and G₃ represent calculation parameters of an empirical correlation equation. In this embodiment, G₁=5.75, G₂=803.6, and G₃=0.3.

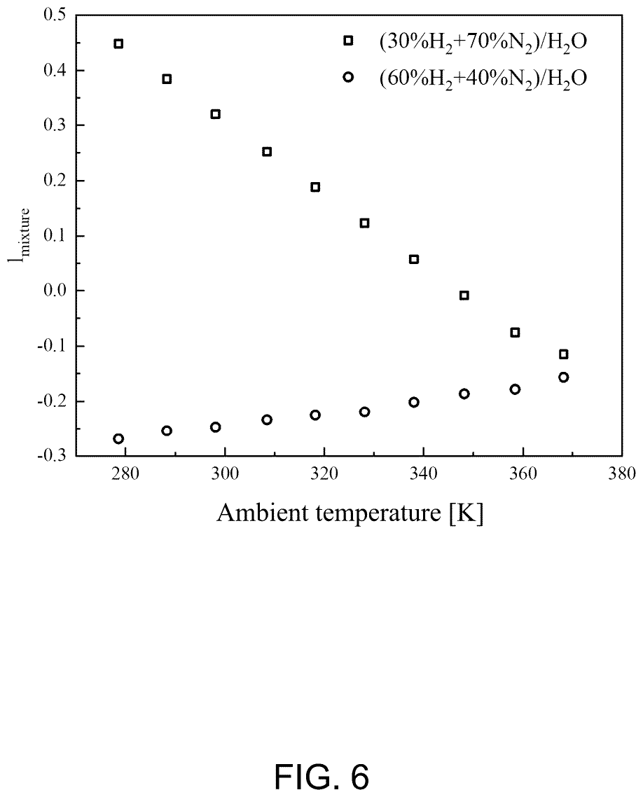

FIG. 6 is a schematic diagram of a result of calculating the interaction coefficient of the mixed gas based on the NRTL equation in the present disclosure.

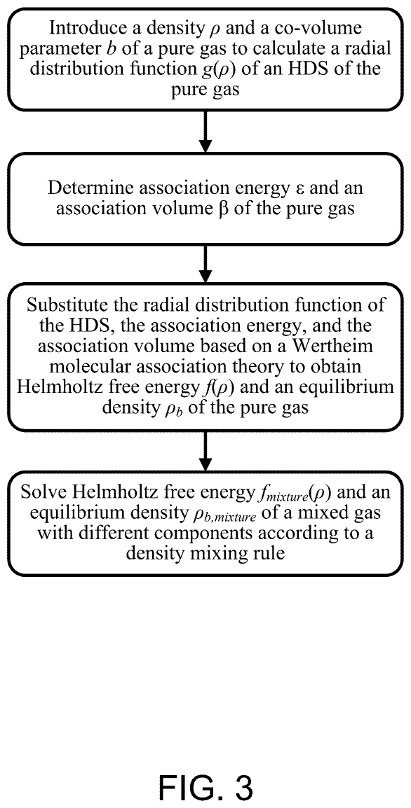

S02: A Helmholtz free energy density and an equilibrium density of the pure gas are determined by using a Wertheim molecular association theory, and Helmholtz free energy fₘᵢₓₜᵤᵣₑ(ρ) and an equilibrium density ρ_{b,mixture} of the (H₂+N₂) mixed gas with different components are determined according to a density mixing rule. As shown in FIG. 3, following steps are included:

S2.1: A pressure factor P is specifically determined as follows:

$$P = - \frac{1}{2} ( 1 + ρ \frac{\partial ln g ( ρ )}{\partial p} ) \sum ( 1 - {X}_{A} )$$

where, ρ represents a molar density; and g(ρ) represents a radial distribution function of an HDS, where the g(ρ) is simplified as follows:

$$g ( ρ ) = \frac{1}{1 - 1.9 η} , η = \frac{1}{4} b ρ$$

X_{A} represents an important parameter for an associated term in a mixture, and is specifically as follows:

$${X}_{A} = \frac{1}{1 + ρ Δ}$$

where, a self-association molecule Δ represents association strength (self-association) between gas molecules, which is given according to a following formula:

$$Δ = g ( ρ ) [ exp ( \frac{ε}{R T} ) - 1 ] b β$$

where, ε represents an association energy of the pure gas; β represents an association volume of the pure gas; and b represents the co-volume parameter of the pure gas, where b is b_{H}_{₂} when calculation is performed on the pure hydrogen and is b_{N}_{₂} when the calculation is performed on the pure nitrogen.

S2.2: The equilibrium density ρ_{b} of the pure gas is obtained according to a following formula:

$${ρ}_{b} = \frac{P}{R T} .$$

Helmholtz free energy f(ρ) of the pure gas is obtained according to a following formula:

$$f ( ρ ) = {μ}_{s} - P * \frac{R T}{{p}_{0}} .$$

where, μₛ represents a chemical potential of the pure gas, and a value of the chemical potential is obtained by looking up a table; and p₀ represents atmospheric pressure of a current environment.

Therefore, an equilibrium density ρ_{H}_{₂}_{b} of the pure hydrogen, an equilibrium density ρ_{N}_{₂}_{b} of the pure nitrogen, Helmholtz free energy f_{H}_{₂}_{(ρ)} of the pure hydrogen, and Helmholtz free energy f_{N}_{₂}_{(ρ)} of the pure nitrogen can be calculated.

S2.3: The Helmholtz free energy fₘᵢₓₜᵤᵣₑ(ρ) and the equilibrium density ρ_{b,mixture} of the mixed gas with different components are specifically solved as follows according to the density mixing rule:

$${f}_{m i x t u r e} ( ρ ) = {x}_{{H}_{2}} {f}_{{H}_{2} ( ρ )} + {x}_{{N}_{2}} {f}_{{N}_{2} ( ρ )} {ρ}_{b , m i x t u r e} = {x}_{{H}_{2}} {ρ}_{{H}_{2} b} + {x}_{{N}_{2}} {ρ}_{{N}_{2} b}$$

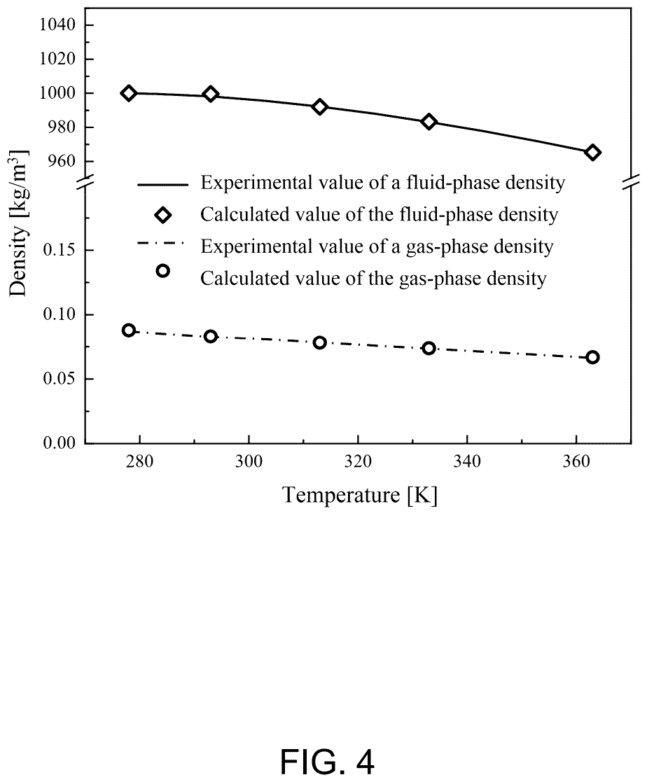

As shown in FIG. 4, a liquid density and a gas-liquid density that are calculated theoretically according to the step S02 are respectively compared with an actually measured liquid density and gas-liquid density, and there is a small error between the calculated value and the actually measured value. From the figure, it can be seen that a simulation result obtained by using the calculation method in the present disclosure has an accuracy of over 98% compared with a result obtained through an experiment.

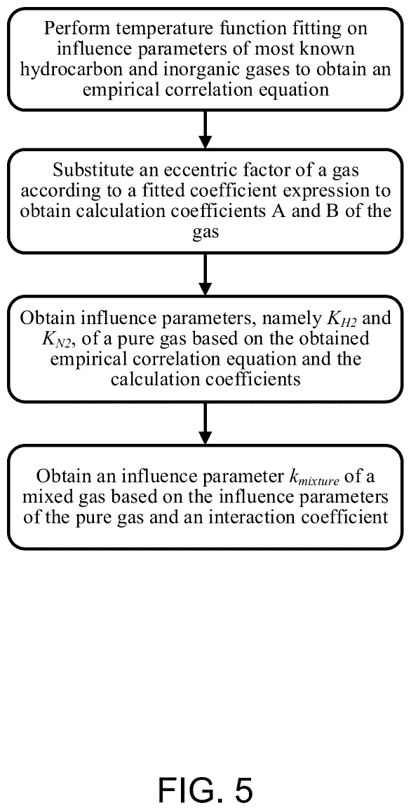

S03: An influence parameter κ of the pure gas is determined based on a GT. Values of influence parameters of a large quantity of known pure gases are fitted to establish an empirical correlation equation about the influence parameter of the pure gas. A value of an influence parameter of the mixed gas is determined by the influence parameter (κ_{H}_{₂}, κ_{N}_{₂}) of the pure gas and the interaction coefficient lₘᵢₓₜᵤᵣₑ together. As shown in FIG. 5, following steps are included:

S3.1: Temperature function fitting is performed on the influence parameters of the large quantity of a pure gas that is known to obtain a general expression. The general expression is as follows:

$$\frac{κ}{{ab}^{2 / 3}} = {A ( 1 - \frac{T}{{T}_{C}} )}^{B}$$

where, coefficient A=f(ω), coefficient B-f(ω²), ω represents an eccentric factor of the pure gas, and the f(ω) and the f(ω²) are determined experimentally based on an influence parameter of the pure gas that is known.

Therefore, an influence parameter κ_{H}_{₂} of the pure hydrogen and an influence parameter κ_{N}_{₂} of the pure nitrogen can be calculated.

S3.2: The influence parameter of the mixed gas is specifically determined based on the influence parameter (κ_{H}_{₂}, κ_{N}_{₂}) of the pure gas and the interaction coefficient lₘᵢₓₜᵤᵣₑ as follows:

$${κ}_{m i x t u r e} = \sqrt{{κ}_{{H}_{2}} {κ}_{{N}_{2}}} ( 1 - {l}_{m i x t u r e} ) .$$

S04: The GT is simplified to obtain a simplified GT theory model LGT by using a density gradient linearization theory

$$\frac{d {ρ}_{\dot{t}} ( z )}{d z} = {C}_{i}$$

and by assuming that a density of a component i in a mixture is linearly distributed between equilibrium phases, without solving an inherent density distribution equation in the GT.

S05: Surface tension is predicted.

Surface tension of a (H₂+N₂)/H₂O system at different temperatures is calculated by combining the simplified GT model LGT and a PR state equation.

The simplified GT model LGT is as follows:

$$γ = {\int }_{{ρ}_{b}^{I}}^{{ρ}_{b}^{Π}} \sqrt{2 κ ( Ω ( ρ ) - {P}_{s} )} d {ρ}_{b , m i x t u r e}$$

where, γ represents a surface tension coefficient, Pₛ represents pressure in a phase equilibrium state, ρ represents a molar density of a bulk phase, superscripts I and II respectively represent components H₂ and N₂ of the mixed gas,

$${ρ}_{b}^{I}$$

represents a hydrogen density under a current component and temperature condition, and

$${ρ}_{b}^{II}$$

represents a nitrogen density under a current component and temperature condition.

Based on the density gradient linearization theory, a corrected influence parameter of the mixed gas is calculated as follows:

$$κ = \sum \sum {κ}_{m i x t u r e} \frac{Δ {ρ}_{{H}_{2}}}{Δ {ρ}_{b}} \frac{Δ {ρ}_{{N}_{2}}}{Δ {ρ}_{b}}$$

where,

$$Δ {ρ}_{b} = max ( {ρ}_{b}^{′} - {ρ}_{b}^{II} ) ,$$

Δρ_{H}_{₂} represents a difference between the hydrogen density and the equilibrium density of the mixed gas, and Δρ_{N}_{₂} represents a difference between the nitrogen density and the equilibrium density of the mixed gas.
Ω(ρ) represents total thermodynamic potential energy, and is defined as follows:

$$Ω ( ρ ) = {f}_{m i x t u r e} ( ρ ) - {ρ}_{b , m i x t u r e} * {μ}_{s , m i x t u r e}$$

where, fₘᵢₓₜᵤᵣₑ(ρ) represents the Helmholtz free energy of the mixed gas when a reference density is ρ, and ρ_{b,mixture} represents the equilibrium density of the mixed gas.

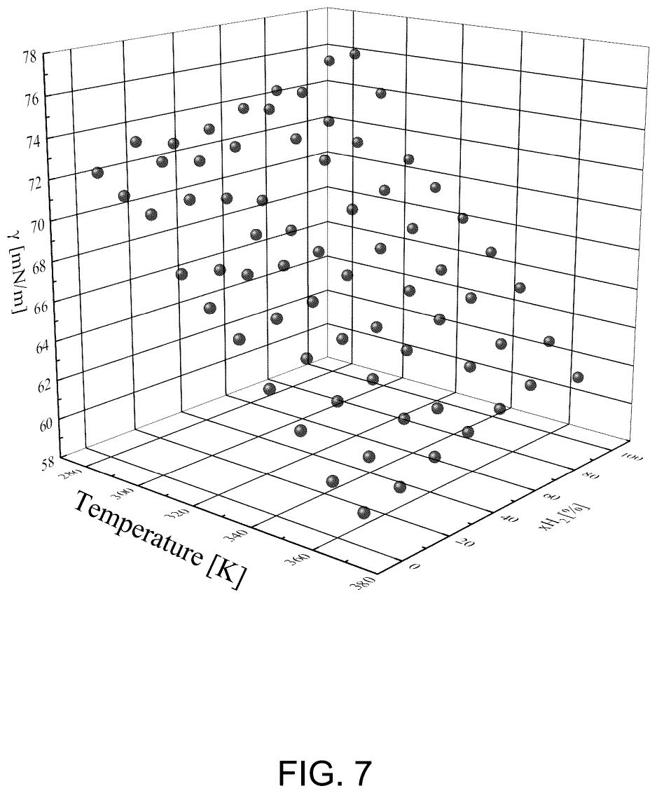

FIG. 7 shows a result of predicting surface tension of a (H₂+N₂)/H₂O system according to the present disclosure.

A system for predicting surface tension of a (H₂+N₂)/H₂O system based on an LGT and a PR state equation in the present disclosure includes a storage medium. The storage medium is configured to store a program for compiling the method for predicting surface tension of a (H₂+N₂)/H₂O system based on the LGT and the PR state equation. The storage medium includes a hard disk, a compact disc read-only memory (CD-ROM), an optical storage device, a magnetic storage device, or a combination thereof. A person skilled in the art should understand that the features described in the specification can be implemented by using a method, a data processing system, or a computer program product. Therefore, these features can be expressed by using hardware only, by using software only, or by using a combination of hardware and software. In addition, the above features can also be expressed in a form of a computer program product stored on one or more computer-readable storage media. The computer-readable storage medium contains a computer-readable program code segment or instruction, which is stored in the storage medium. Any computer-readable storage medium may be used, including a hard disk, a CD-ROM, an optical storage device, a magnetic storage device, and/or a combination thereof.

It should be understood that although the specification is described in accordance with the embodiments, not every embodiment only includes one independent technical solution. This description of the specification is for the sake of clarity only. Those skilled in the art should take the specification as a whole, and the technical solutions in the embodiments can also be appropriately combined to form other implementations that can be understood by those skilled in the art.

The detailed description listed above is only specific illustration of feasible embodiments of the present disclosure, rather than limiting the claimed scope of the present disclosure. All equivalent embodiments or changes made without departing from the technical spirit of the present disclosure should be included in the claimed scope of the present disclosure.

What is claimed is:

1. A method for predicting surface tension of a (H₂+N₂)/H₂O system based on a linear gradient theory (LGT) and a Perkins-Rammler (PR) state equation, comprising following steps:
determining an energy parameter and a co-volume parameter of a pure gas based on the PR state equation, and determining a material parameter and a co-volume parameter of a mixed gas according to a Waals one-fluid mixing rule and a combination rule;
determining a Helmholtz free energy density and an equilibrium density of the pure gas by using a Wertheim molecular association theory, and determining a Helmholtz free energy fₘᵢₓₜᵤᵣₑ(ρ) and an equilibrium density ρ_{b,mixture} of a (H₂+N₂) mixed gas with different components according to a density mixing rule;
determining an influence parameter κ of the pure gas by using a gradient theory, and determining an influence parameter of the mixed gas based on the influence parameter (κ_{H}_{₂}, κ_{N}_{₂}) of the pure gas and an interaction coefficient lₘᵢₓₜᵤᵣₑ;
simplifying a gradient theory model to obtain a simplified gradient theory model, namely an LGT model; and
obtaining the surface tension of the (H₂+N₂)/H₂O system at different temperatures by combining the LGT model and the PR state equation.

2. The method for predicting the surface tension of the (H₂+N₂)/H₂O system based on the LGT and the PR state equation according to claim 1, wherein the determining the energy parameter and the co-volume parameter of the pure gas based on the PR state equation, and determining the material parameter and the co-volume parameter of the mixed gas according to the Waals one-fluid mixing rule and the combination rule comprises following steps:
determining the energy parameter [symbol] and the co-volume parameter [symbol] of the pure gas based on a thermophysical parameter of the pure gas, specifically as follows:
$${a}_{} = 0.46 \frac{{( {RT}_{c} )}^{2}}{{p}_{c}} {α ( T )}_{}$$
$${b}_{} = 0.08 \frac{{RT}_{c}}{{p}_{c}}$$
$${α ( T )}_{} = {[ 1 + {m}_{} ( 1 - \sqrt{\frac{T}{{T}_{c}}} ) ]}^{2}$$
wherein, T_{c} represents a critical temperature of the pure gas, p_{c} represents a critical pressure of the pure gas, R represents a gas constant, T represents an ambient temperature, and [symbol] represents a coefficient related to an eccentric factor of the pure gas;
according to the above formulas, obtaining a thermophysical parameter of pure nitrogen to determine an energy parameter a_{N}_{₂} and a co-volume parameter b_{N}_{₂} of the pure nitrogen, and obtaining a thermophysical parameter of pure hydrogen to determine an energy parameter a_{H}_{₂} and a co-volume parameter b_{H}_{₂} of the pure hydrogen; and
determining the material parameter aₘᵢₓₜᵤᵣₑ and the co-volume parameter bₘᵢₓₜᵤᵣₑ of the mixed gas with different components according to the Waals one-fluid mixing rule as follows:
$$\{ \begin{matrix}{α}_{m i x t u r e} = \sqrt{{x}_{{H}_{2}} {x}_{{N}_{2}} {a}_{{H}_{2}} {a}_{{N}_{2}}} ( 1 - {k}_{m i x t u r e} ) \\ {b}_{m i x t u r e} = \frac{1}{2} ( {x}_{{H}_{2}} {b}_{{H}_{2}} + {x}_{{N}_{2}} {b}_{{N}_{2}} ) ( 1 - {l}_{m i x t u r e} )\end{matrix}$$
wherein lₘᵢₓₜᵤᵣₑ represents the interaction coefficient of the mixed gas, wherein the interaction coefficient lₘᵢₓₜᵤᵣₑ of the mixed gas with different components is calculated based on a non-random two liquid (NRTL) equation; x_{H}_{₂} represents a volume fraction of hydrogen in the mixed gas; x_{N}_{₂} represents a volume fraction of nitrogen in the mixed gas; kₘᵢₓₜᵤᵣₑ represents a binary interaction parameter, wherein for a (H₂+N₂) mixed gas, the binary interaction parameter kₘᵢₓₜᵤᵣₑ is defined as follows:
$${k}_{m i x t u r e} = 0.99 - \frac{379.97}{T} .$$

3. The method for predicting the surface tension of the (H₂+N₂)/H₂O system based on the LGT and the PR state equation according to claim 2, wherein the interaction coefficient lₘᵢₓₜᵤᵣₑ of the mixed gas with different components is specifically calculated as follows based on the NRTL equation:
fitting experimental data to obtain a binary interaction coefficient l_{H}_{₂} of the pure hydrogen and a binary interaction coefficient l_{N}_{₂} of the pure nitrogen; and
calculating values of the interaction coefficient lₘᵢₓₜᵤᵣₑ of the mixed gas with different components at different temperatures based on the NRTL equation, wherein a calculation formula is as follows:
$$ln ( {l}_{m i x t u r e} ) = {{x}_{{H}_{2}}}^{2} * ( \frac{{G}_{1}}{R T} ) * {l}_{{H}_{2}} + {{x}_{{N}_{2}}}^{2} * ( \frac{{G}_{2}}{R T} ) * {l}_{{N}_{2}} + 2 {x}_{{H}_{2}} {x}_{{N}_{2}} * ( \frac{{G}_{3}}{R T} )$$
wherein, G₁, G₂, and G₃ represent calculation parameters of an empirical correlation equation.

4. The method for predicting the surface tension of the (H₂+N₂)/H₂O system based on the LGT and the PR state equation according to claim 2, wherein the determining the Helmholtz free energy density and the equilibrium density of the pure gas by using the Wertheim molecular association theory comprises following steps:
determining a pressure factor P as follows:
$$P = - \frac{1}{2} ( 1 + ρ \frac{\partial ln g ( ρ )}{\partial ρ} ) \sum ( 1 - {X}_{A} )$$
wherein ρ represents a molar density; and g(ρ) represents a radial distribution function of a hard sphere (HDS), wherein the g(ρ) is simplified as follows:
$$g ( ρ ) = \frac{1}{1 - 1.9 η} , η = \frac{1}{4} b ρ$$
X_{A} represents an important parameter for an associated term in a mixture, and is specifically as follows:
$${X}_{A} = \frac{1}{1 + ρ Δ}$$
wherein a self-association molecule Δ represents association strength (self-association) between gas molecules, which is given according to a following formula:
$$Δ = g ( ρ ) [ exp ( \frac{ε}{R T} ) - 1 ] b β$$
wherein ε represents an association energy of the pure gas; β represents an association volume of the pure gas; and b represents the co-volume parameter of the pure gas, and b is b_{H}_{₂} when calculation is performed on pure hydrogen and is b_{N}_{₂} when the calculation is performed on pure nitrogen;
obtaining the equilibrium density ρ_{b} of the pure gas according to a following formula:
$${ρ}_{b} = \frac{P}{R T} ;$$
obtaining the Helmholtz free energy f(ρ) of the pure gas according to a following formula:
$$f ( ρ ) = {μ}_{s} - P * \frac{R T}{{p}_{0}} ;$$
wherein μₛ represents a chemical potential of the pure gas, and a value of the chemical potential is obtained by looking up a table; and p₀ represents atmospheric pressure of a current environment; and
obtaining an equilibrium density ρ_{H}_{₂}_{b} of the pure hydrogen, an equilibrium density ρ_{N}_{₂}_{b} of the pure nitrogen, Helmholtz free energy f_{H}_{₂}_{(ρ)} of the pure hydrogen, and Helmholtz free energy f_{N}_{₂}_{(ρ)} of the pure nitrogen.

5. The method for predicting the surface tension of the (H₂+N₂)/H₂O system based on the LGT and the PR state equation according to claim 4, wherein the determining the Helmholtz free energy fₘᵢₓₜᵤᵣₑ(ρ) and the equilibrium density ρ_{b,mixture} of the (H₂+N₂) mixed gas with different components according to the density mixing rule is specifically as follows:
$${f}_{m i x t u r e} ( ρ ) = {x}_{{H}_{2}} {f}_{{H}_{2} ( ρ )} + {x}_{{N}_{2}} {f}_{{N}_{2} ( ρ )}$$
$${ρ}_{b , m i x t u r e} = {x}_{{H}_{2}} {ρ}_{{H}_{2} b} + {x}_{{N}_{2}} {ρ}_{{N}_{2} b} .$$

6. The method for predicting the surface tension of the (H₂+N₂)/H₂O system based on the LGT and the PR state equation according to claim 1, wherein the determining the influence parameter κ of the pure gas by using the gradient theory specifically comprises following steps:
performing temperature function fitting on an influence parameter of a pure gas that is known, to obtain a general expression, wherein the general expression is as follows:
$$\frac{κ}{{ab}^{2 / 3}} = {A ( 1 - \frac{T}{{T}_{C}} )}^{B}$$
wherein coefficient A=f(ω), coefficient B=f(ω²), ω represents an eccentric factor of the pure gas, and the f(ω) and the f(ω²) are determined experimentally based on an influence parameter of the pure gas that is known; and
calculating an influence parameter κ_{H}_{₂} of pure hydrogen and an influence parameter κ_{N}_{₂} of pure nitrogen.

7. The method for predicting the surface tension of the (H₂+N₂)/H₂O system based on the LGT and the PR state equation according to claim 6, wherein the determining the influence parameter of the mixed gas based on the influence parameter (κ_{H}_{₂}, κ_{N}_{₂}) of the pure gas and the interaction coefficient lₘᵢₓₜᵤᵣₑ is specifically as follows:
the influencer parameter of the mixed has κₘᵢₓₜᵤᵣₑ=\sqrt{κ_{H}_{₂}κ_{N}_{₂}}(1−lₘᵢₓₜᵤᵣₑ).

8. The method for predicting the surface tension of the (H₂+N₂)/H₂O system based on the LGT and the PR state equation according to claim 1, wherein the simplifying the gradient theory model is specifically as follows: obtaining the simplified gradient theory model, namely the LGT model, by using a density gradient linearization theory and by assuming that a density of a component i in a mixture is linearly distributed between equilibrium phases, without solving an inherent density distribution equation in the gradient theory.

9. The method for predicting the surface tension of the (H₂+N₂)/H₂O system based on the LGT and the PR state equation according to claim 1, wherein the surface tension of the (H₂+N₂)/H₂O system at the different temperatures is obtained by combining the LGT model and the PR state equation;
the simplified gradient theory model, namely the LGT model is as follows:
$$γ = {\int }_{{ρ}_{b}^{I}}^{{ρ}_{b}^{Π}} \sqrt{2 κ ( Ω ( ρ ) - {P}_{s} )} d {ρ}_{b , m i x t u r e}$$
wherein γ represents a surface tension coefficient, Pₛ represents a pressure in a phase equilibrium state, ρ represents a molar density of a bulk phase, superscripts I and II respectively represent components H₂ and N₂ of the mixed gas,
$${ρ}_{b}^{I}$$
represents a hydrogen density under a current component and temperature condition, and
$${ρ}_{b}^{II}$$
represents a nitrogen density under a current component and temperature condition;
based on a density gradient linearization theory, a corrected influence parameter of the mixed gas is calculated as follows:
$$κ = \sum \sum {κ}_{m i x t u r e} \frac{Δ {ρ}_{{H}_{2}}}{Δ {ρ}_{b}} \frac{Δ {ρ}_{{N}_{2}}}{Δ {ρ}_{b}}$$
wherein
$$Δ {ρ}_{b} = max ( {ρ}_{b}^{′} - {ρ}_{b}^{II} ) , Δ {ρ}_{{H}_{2}}$$
represents a difference between the hydrogen density and the equilibrium density of the mixed gas, and Δρ_{N}_{₂} represents a difference between the nitrogen density and the equilibrium density of the mixed gas; and
Ω(ρ) represents total thermodynamic potential energy, and is defined as follows:
$$Ω ( ρ ) = {f}_{m i x t u r e} ( ρ ) - {ρ}_{b , m i x t u r e} * {μ}_{s , m i x t u r e}$$
wherein fₘᵢₓₜᵤᵣₑ(ρ) represents the Helmholtz free energy of the mixed gas when a reference density is ρ, and ρ_{b,mixture} represents the equilibrium density of the mixed gas.

10. A system for predicting surface tension of a (H₂+N₂)/H₂O system based on the LGT and the PR state equation, comprising a storage medium, wherein the storage medium is configured to store a program for compiling the method for predicting the surface tension of the (H₂+N₂)/H₂O system based on the LGT and the PR state equation according to claim 1.

11. A system for predicting surface tension of a (H₂+N₂)/H₂O system based on the LGT and the PR state equation, comprising a storage medium, wherein the storage medium is configured to store a program for compiling the method for predicting the surface tension of the (H₂+N₂)/H₂O system based on the LGT and the PR state equation according to claim 2.

12. A system for predicting surface tension of a (H₂+N₂)/H₂O system based on the LGT and the PR state equation, comprising a storage medium, wherein the storage medium is configured to store a program for compiling the method for predicting the surface tension of the (H₂+N₂)/H₂O system based on the LGT and the PR state equation according to claim 3.

13. A system for predicting surface tension of a (H₂+N₂)/H₂O system based on the LGT and the PR state equation, comprising a storage medium, wherein the storage medium is configured to store a program for compiling the method for predicting the surface tension of the (H₂+N₂)/H₂O system based on the LGT and the PR state equation according to claim 4.

14. A system for predicting surface tension of a (H₂+N₂)/H₂O system based on the LGT and the PR state equation, comprising a storage medium, wherein the storage medium is configured to store a program for compiling the method for predicting the surface tension of the (H₂+N₂)/H₂O system based on the LGT and the PR state equation according to claim 5.

15. A system for predicting surface tension of a (H₂+N₂)/H₂O system based on the LGT and the PR state equation, comprising a storage medium, wherein the storage medium is configured to store a program for compiling the method for predicting the surface tension of the (H₂+N₂)/H₂O system based on the LGT and the PR state equation according to claim 6.

16. A system for predicting surface tension of a (H₂+N₂)/H₂O system based on the LGT and the PR state equation, comprising a storage medium, wherein the storage medium is configured to store a program for compiling the method for predicting the surface tension of the (H₂+N₂)/H₂O system based on the LGT and the PR state equation according to claim 7.

17. A system for predicting surface tension of a (H₂+N₂)/H₂O system based on the LGT and the PR state equation, comprising a storage medium, wherein the storage medium is configured to store a program for compiling the method for predicting the surface tension of the (H₂+N₂)/H₂O system based on the LGT and the PR state equation according to claim 8.

18. A system for predicting surface tension of a (H₂+N₂)/H₂O system based on the LGT and the PR state equation, comprising a storage medium, wherein the storage medium is configured to store a program for compiling the method for predicting the surface tension of the (H₂+N₂)/H₂O system based on the LGT and the PR state equation according to claim 9.
